(19) United States
(12) Patent Application Publication
(10) Pub. No.: US 2018/0005129 A1
(43) Pub. Date: Jan. 4, 2018

(54) PREDICTIVE CLASSIFICATION IN ACTION SPORTS

(71) Applicants: Stephanie Moyerman, Phoenix, AZ (US); James Brian Hall, Tucson, AZ (US); Tyler Fetters, Hillsboro, OR (US); Caleb Ozer, Berkeley, CA (US)

(72) Inventors: Stephanie Moyerman, Phoenix, AZ (US); James Brian Hall, Tucson, AZ (US); Tyler Fetters, Hillsboro, OR (US); Caleb Ozer, Berkeley, CA (US)

(21) Appl. No.: 15/197,074

(22) Filed: Jun. 29, 2016

(51) Int. Cl. G06N 7/00; H04W 4/00; G06N 5/02

(52) U.S. Cl. CPC G06N 7/005; G06N 5/02; H04W 4/008

(57) ABSTRACT

Systems and techniques for predictive classification in action sports are described herein. A start point for an action may be identified in a data stream including a plurality of data sets corresponding to the action. The data stream may be collected from a sensor array. Action performance features may be extracted from the data stream subsequent to the start point. The action performance features may be compared in real-time to a set of statistical models. A label may be selected for the action based on the comparison. A likelihood of success may be generated for the action based on the comparison. The label for the action and the likelihood of success may be output for display on a display device.

### BACKGROUND

Classification of complex motions from captured sensor data may be a complex and computationally costly procedure. While techniques exist for quantifying simple actions, such as step counting, more complex actions may still lack accuracy in quantification. Further, the quantification of simple actions may involve analyzing to a single number (e.g. a number of steps). Algorithms describing the quality of step or length of stride may use algorithms that may be power hungry, as much more data may be analyzed.

### BRIEF DESCRIPTION OF THE DRAWINGS

To easily identify the discussion of any particular element or act, the most significant digit or digits in a reference number refer to the figure number in which that element is first introduced.

FIG. 1 illustrates an environment including a predictive classifier for predictive classification in action sports, according to various embodiments.

FIG. 2 illustrates an example of a sensor hub for predictive classification in action sports, according to various embodiments.

FIG. 3 illustrates a graph of an example data stream from a sensor array for predictive classification in action sports, according to various embodiments.

FIG. 4 illustrates an example of a system for predictive classification in action sports, according to various embodiments.

FIG. 5 illustrates a flowchart of an example of a method for predictive classification in action sports, according to various embodiments.

FIG. 6 illustrates a flowchart of an example of a method for predictive classification in action sports, according to various embodiments.

FIG. 7 illustrates a flowchart of an example of a method for predictive classification in action sports, according to various embodiments.

FIG. 8 is a block diagram illustrating an example of a machine upon which one or more embodiments may be implemented.

### DETAILED DESCRIPTION

Motion classification may be a technically complex task. In particular, in action sports such as snowboarding, a participant (e.g., a snowboarder, skier, skateboarder, wakeboarder, etc.) may be moving down a slope and may interact with a variety of obstacles (e.g., jumps, rails, and other terrain elements). The participant may complete a run down the slope and through the obstacles completing a series of complex movements (e.g., jumps, flips, turns, etc.). The run may include segments of relative non-action (e.g., a period of time the participant takes between obstacles, etc.) and segments during which actions (e.g., tricks, etc.) are performed (e.g., an aerial trick completed off of a jump, etc.). Existing techniques for sports tracking and analytics may post-process an entire event or time stream in order to detect that an event has happened. In an action sports context, a participant may perform the entire action before the existing techniques may be able detect that the action has taken place. By the time the jump is detected, the participant may back on the ground and the action may be complete. Existing techniques may not exist for detecting these actions in real-time or near real-time. For example, existing techniques may log data to a device and data analysis may be completed after the action is complete.

Existing techniques may not provide the ability to provide predictive analytics in real-time or near real-time. The present subject matter may combine data streaming with real-time analytics and reporting to address this shortcoming of existing techniques. With the growing popularity of action sports and high-level action sports competitions (e.g., X Games, Olympics, etc.), the importance of real-time detection, quantization, and scoring of actions in action sports may increase.

Systems and techniques are disclosed for performing real-time and near real-time analytics for action sports. The present subject matter may dramatically improve pattern recognition of actions in action sports from sensor data compared to existing techniques. While examples provided discuss snowboarding, it may be understood that the present subject matter may be applied to many action sports such as, for example BMX ramp, skiing, skateboarding ramp, wakeboarding, etc.

The present subject matter may classify and quantify action sports data in real-time by fusing the sensor data from multiple sensors in a sensor array. Thus, multiple sets of independent sensor data may allow more accurate classification of complex motion combinations (e.g., tricks). For example, an aerial jump may include several dimensions of movement that may be difficult to accurately identify with a single sensor reading. Thus, the present subject matter may employ a sensor array combining a variety of sensors to capture a more robust data set to provide increased accuracy. For example, a user may mount a sensor array to their equipment (e.g., snowboard, skateboard, bike, etc.).

Early detection and knowledge of an action may allow predictive analytics to predict an outcome for an action. For example, detecting that a snowboarder is about to jump or has started to jump may act a flag that may trigger the beginning of analytical processing of incoming sensor data. Raw data from the sensor array may be streamed via long range radios and fiber optic cable to a central computing hub. Actions may be detected in real-time and near real-time by applying an algorithm to the streaming raw data. For example, a jump pattern may be recognized less than 5 sample point from the start point of the jump. Statistics for an identified action may then be processed in real-time as opposed to being analyzed in post processing. The speed of detection of an action may be as fast as a rate at which data may be read from the sensor (e.g., ˜10-200 milliseconds). Faster sensors may lead to a reduction in detection latency. The present subject matter may increase computational efficiency as the computation time for action detection may be less than the rate at which data may be streamed from the sensors.

In some examples, data from before the detection of the start of an action may be analyzed along with the real-time data to form a more accurate prediction of the success of the action and derive a predicted score for the action or a set of actions performed during a participant's run. Alternatively or additionally, a user may provide a goal action (e.g., a snowboarder may have a goal of completing a frontside doublecork 1260 (a trick including a series of spins including left, right, up, and down rotation while in aerial flight) off of a jump, etc.). Data regarding the goal action may be used in predicting the outcome of a current performance of the goal activity.

Regression analysis may be applied to training data to develop prediction models for various actions. For example, several snowboarders may complete a tailgrab (e.g., grabbing the tail end of the snowboard while in aerial flight) off of a jump with a sensor array affixed to their respective snowboards and each attempt may be assigned a success or failure label. The data collected from the sensor array for each attempt may be processed using regression analysis to generate models indicating the relationship between various data elements (e.g., rotation, height, speed, etc.) and success or failure of a tailgrab attempt. Data sets corresponding to an action (e.g., a tailgrab, etc.) detected during a run may then be compared to a model as the data is received to predict the likelihood that the participant may complete the action successfully.

The present subject matter may provide a variety of advantages. The present subject matter may provide a dramatic improvement in the speed of pattern recognition in action sports as detection may be completed in real-time as opposed to analyzing data after the action has been completed. In addition, statistics may be aggregated in real-time and may be used for real-time statistical analysis which may be suitable for a live events or events broadcasted live.

The present subject matter may be hardware scalable because sensors outputting at various frequencies (e.g., ˜50 Hz-400 Hz or more) may be used interchangeably with pattern recognition being accelerated as faster sensors are added. In other words, as sensor data input speed increases the speed of pattern recognition increases.

The present subject matter may result may result in an increase in computational efficiency over existing techniques because the present subject matter employs lightweight algorithms that may be performed on board the sensor array. For example, the compute time may be significantly less than the latency between data samples and may require little memory to process data. The applicability of the present subject matter to increase the speed of pattern recognition across a broad range of action sports may also decrease the use of specialized hardware for individual action sports.

It may be understood that the present subject matter may be utilized in a variety of situations including, but not limited to, automated real-time coaching feedback, real-time user feedback, enhanced live event data and statistics tracking, scoring, judging, broadcast data and statistics, and real-time trick competitions for athletes at different locations worldwide.

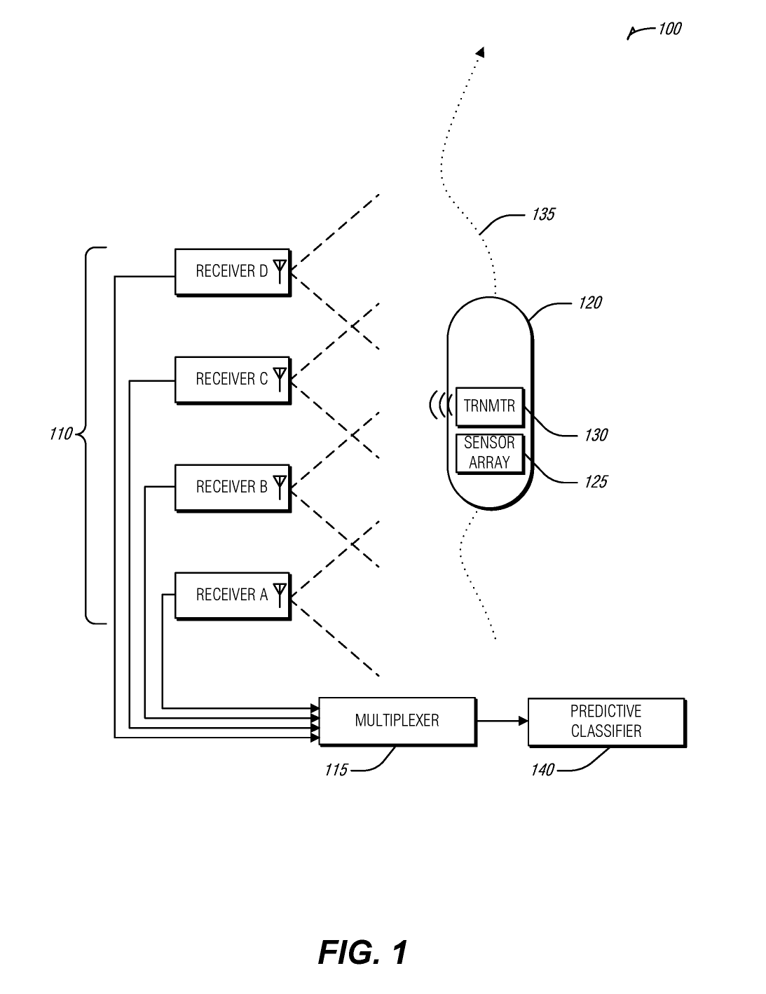

FIG. 1 illustrates an environment 100 including an action detection engine 140, according to various embodiments. The environment 100 may include an action sports course (e.g., a downhill slope for snowboarding, a snowboard terrain park, a ski slope, a skateboard park, a wake board course, etc.). The action sports course may include a set of receivers 110 (e.g., 900 MHz radio receivers, etc.) positioned along a path 135 of a participant (e.g., a snowboarder, skateboarder, wake boarder, skier, etc.)

A sensor array 125 (e.g., a hub including various sensor devices, etc.) may be affixed to a sporting device 120 (e.g., snowboard, skateboard, skis, wake board, etc.) of the participant. For example, a sensor array may be attached to the top of a snowboard. The sensor array 125 may include a variety of sensors such as, for example, an accelerometer, a gyroscope, a magnetometer, a global positioning system (GPS) receiver, a barometer, etc. Each of the sensors may provide a set of data regarding the movement of the sporting device 120 and the environment in which the sporting device 120 is used which may be imputed to the participant.

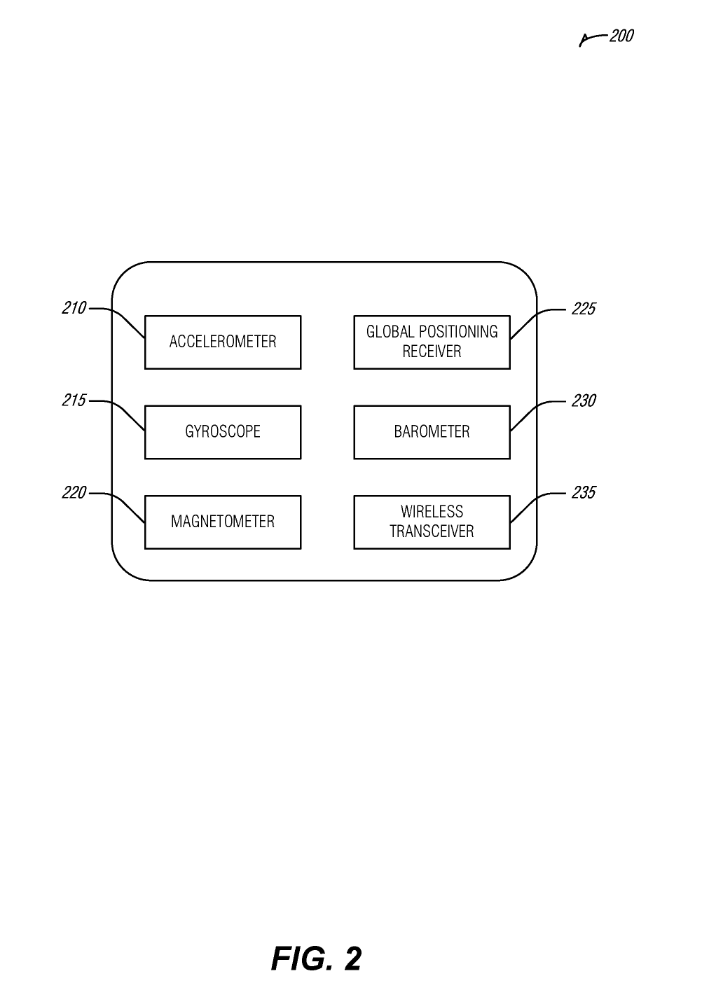

A transceiver 130 (e.g., a 900 MHz wireless transceiver, Wi-Fi transceiver, etc.) may also be affixed to the sporting device 120 of the participant. In some examples, the transceiver 130 may be included in a device including the sensor array 130. The transceiver 130 may be communicatively coupled to the set of receivers 110 (e.g., via wideband radio communication, Wi-Fi, etc.). The transceiver 130 may transmit data from the sensor array 125 to the set of receivers 110 as the participant proceeds through course (e.g., along the path of the participant 135). For example, the transceiver may send sensor data to the set of receivers 110 as the participant proceeds down a course and through and over obstacles. The set of receivers 110 may be arranged along the course in a configuration minimizing the risk of signal loss to ensure a complete set of sensor data is received. In some examples, the location of the set of receivers may be used in analyzing the received data (e.g., to triangulate the participant's position, etc.). In some examples, the sensor array 125 and the transceiver 130 may be combined included in a sensor hub. The sensor hub may be affixed to the sporting device 120. An example of a sensor hub is provided in FIG. 2.

The set of receivers 110 may be communicatively coupled to a multiplexer 115 using a high speed connection (e.g., fiber optic cable, etc.). For example, the multiplexer may act as an aggregation hub acting as a termination point for each receiver of the set of receivers 110. The multiplexer 115 may process data received from the sensor array 125. In some examples, the multiplexer 115 may generate timestamps for the participant's run thorough the action sports course. For example, a sensor may provide data at 1 millisecond (ms) intervals and the multiplexer may assign timestamps for the sensor data at 1 ms intervals. The multiplexer 115 may then generate a single set (or multiple sets) of sensor data for each timestamp.

The multiplexer 115 may discard duplicate sensor data. For example, two acceleration values for along an axis may be received at receiver A and receiver B for the same timestamp and the multiplexer 115 may discard one of the values. The multiplexer 115 may reduce the collected sensor data for the timestamp to a single set. For example, the multiple data sets may be received from the set of receivers 110 and the multiplexer 115 may aggregate the multiple data sets into a single data set. A variety of techniques may be used to determine the single set of sensor data. For example, the multiplexer 115 may average the sensor data received from receiver A and receiver B, discard data points that appear to be outliers (e.g., outside a standard deviation of received data, discard duplicate data points based on the respective geographical locations of receivers (e.g., data points received from receiver B may be preferred over data points received from receiver A for a given timestamp based on the participant's location on the action sports course, etc.).

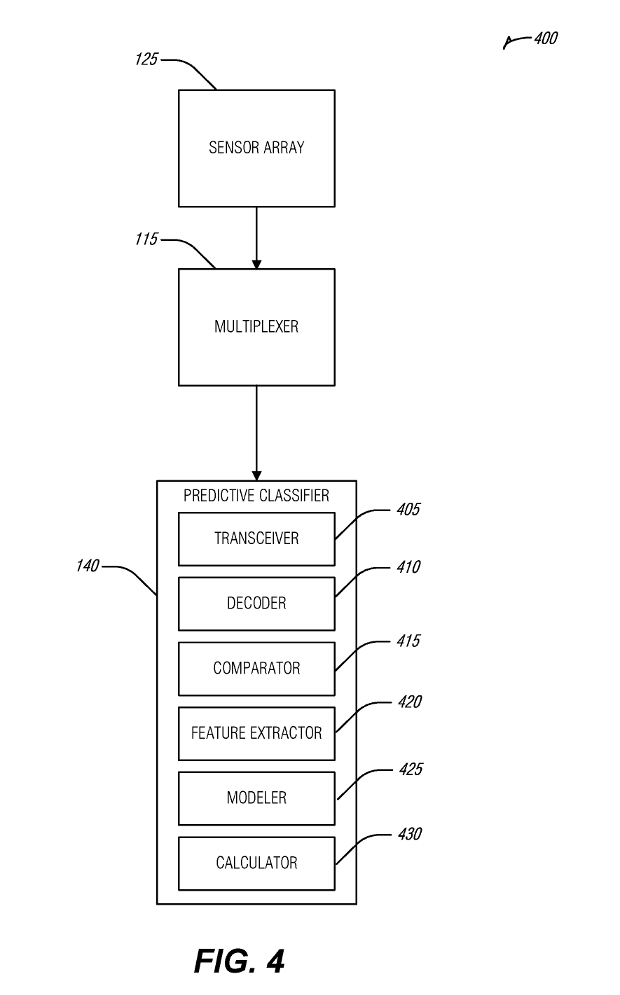

The multiplexer 115 may be communicatively coupled to a predictive classifier 140 (e.g., via high speed network, shared physical bus, etc.). The multiplexer 115 may transmit sets of sensor data to the predictive classifier 140 along with corresponding timestamps. For example, the multiplexer 115 may provide a data stream including data sets arranged by timestamp. The predictive classifier 140 may analyze the set of sensor data to predict the success of an action (e.g., a trick, etc.) performed by the participant. The predictive classifier 140 may analyze the set of sensor data to predict a score for an action or a collection of actions performed during a participant's run through an action sports course. The predictive classifier 140 is discussed in greater detail in the description of FIG. 4.

FIG. 2 illustrates an example of a sensor hub 200 for accelerated pattern matching in action sports, according to various embodiments. The sensor hub 200 may include a sensor array providing functionality similar to the sensor array 125 as described in FIG. 1. The sensor hub may include a plurality of sensors such as accelerometer 210, gyroscope 215, magnetometer 220, GPS receiver 225, and barometer 230. In some examples, the sensor array 200 may include a transceiver 130 (e.g., 900 MHz radio, etc.).

Data from each sensor of the plurality of sensors may be transmitted using the transceiver 130. For example, the raw data may be streamed over a 900 MHz radio from a sporting device (e.g., a snowboard, skis, skateboard, wake board, etc.) used by a participant of an action sport (e.g., a snowboarder, skier, skateboarder, wake boarder, etc.) to radio receivers along the course (e.g., the set of receivers 110 as described in FIG. 1), which transmit the signal through fiber optic cables to a central hub (e.g., the multiplexer 115 as described in FIG. 1). The raw data streamed from the sensor array may correspond to respective timestamps and the central hub may return a single set of data for each timestamp. In other words, duplicate data may be discarded.

Various sampling frequencies may be employed for each sensor. The sampling frequency of each sensor may be independent from (or the same as) other sensors of the plurality of sensors. For example, raw 3-axis (e.g., x, y, and z axis in a three dimensional coordinate system, etc.) accelerometer (e.g., from accelerometer 210), 3-axis gyroscope (e.g., from gyroscope 215), 3-axis magnetometer (e.g., from magnetometer 220), barometric pressure (e.g., from barometer 230), and temperature data (e.g., from a thermometer included in the sensor array) may be sampled at a sampling frequency of F, where F≧100 Hz, which may provide higher classification accuracy. For example, GPS data including latitude, longitude, speed, and altitude (e.g., from the GPS receiver 225) may be streamed at a lower sampling frequency, F≧5 Hz, which may provide greater data accuracy.

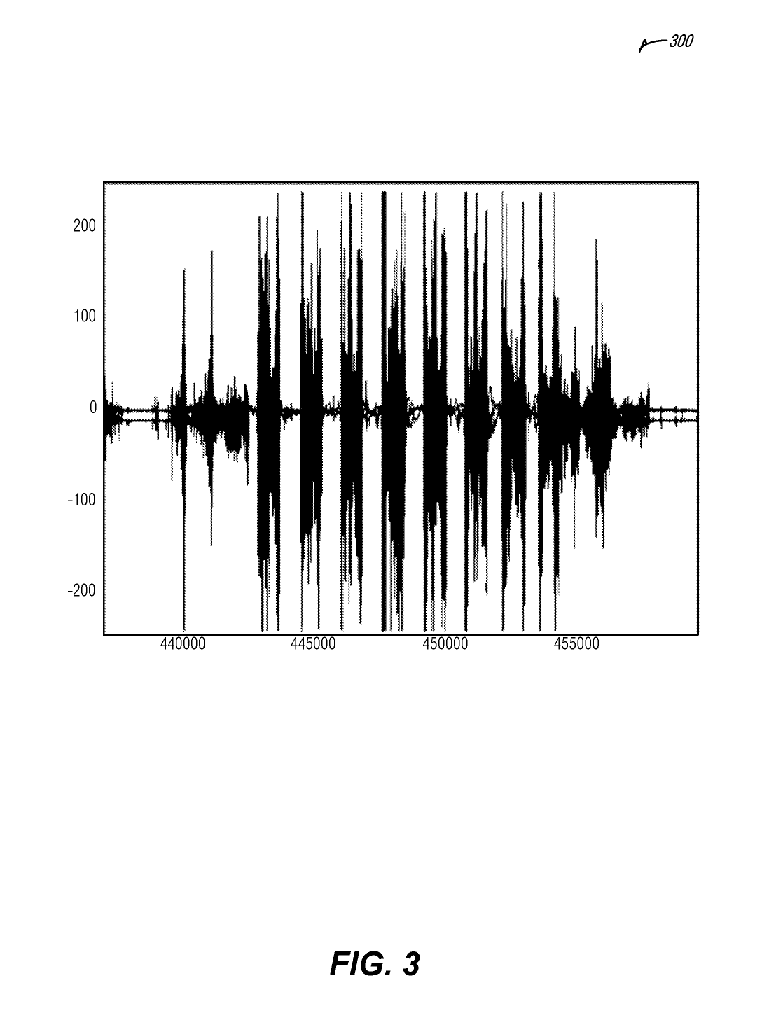

FIG. 3 illustrates a graph 300 of an example data stream from a sensor array (e.g., sensor array 125 as described in FIG. 1, sensor hub 200 as described in FIG. 2, etc.), according to various embodiments. The example data stream may include acceleration data collected from the sensors of the sensor array including, for example, an accelerometer, a gyroscope, and a magnetometer. The graph 300 illustrates a series of peaks and valleys in the sensor data over a period of time. The example set of data may illustrate a run of a participant (e.g., snowboarder, etc.) of an action sport (e.g., snowboarding, etc.). The peaks and valleys may delineate between action segments (e.g., where a trick is being performed, etc.) and non-action segments (e.g., periods between actions, etc.) in the example data stream. The example data stream may be analyzed by a predictive classifier (e.g., predictive classifier 140) to determine the beginning and end of the action. The example data stream may be analyzed to calculate statistics corresponding to the action (e.g., by the transformer 420 as described in FIG. 4). Additional detail of an action detection and analysis is provided in FIG. 4.

FIG. 4 illustrates an example of a system 400 for predictive classification in action sports, according to various embodiments. The system 400 may include a sensor array 125 (e.g., as described in FIG. 1) communicatively coupled (e.g., via wireless network, etc.) to a multiplexer 115 (e.g., as described in FIG. 1). The multiplexer 115 may be communicatively coupled to a predictive classifier 140. The predictive classifier 140 may include a variety of components such as a transceiver 405, a decoder 410, a comparator 415, a feature extractor 420, a modeler 425, and a calculator 430.

A participant of an action sport (e.g., snowboarding, etc.) may begin a run down a slope including various terrain and obstacle elements. For example, in slopestyle snowboarding, a participant may travel down a slope including a variety of jumps, rails, tabletops, and other terrain elements. In skateboarding a skateboarder may travel through a course including a variety of ramps, rails, table tops, and other terrain elements. The participant may have the sensor array 125 affixed to sporting device used in participation of the action sport. For example, a snowboarder may be completing a run down a slope and performing a variety of actions (e.g., jumps, flips, turns, etc.) with the sensor array 125 affixed to a snowboard. In an example, the sensor array 125 may include an accelerometer, a gyroscope, and a magnetometer. In an example, the sensor array 125 may include a GPS receiver. In an example, the sensor array 125 may include a barometer.

The sensor data from the sensor array 125 may be sent via a wireless transceiver to a set of receivers positioned along the course (e.g., as described in FIG. 1). The sensor data may be received and processed by the multiplexer 115 (e.g., as described in FIG. 1). In some examples, a plurality of data sets from a data stream may be received from the sensor array 125. For example, the plurality of data sets may include a variety of data sets received from various sensors in the sensor array 125 affixed to the snowboard received by the set of receivers.

The transceiver 405 may process incoming data such as the data provided by the multiplexer 115. For example, the incoming data may be data from the sensor array 125 affixed to the snowboard of the snowboarder. A data stream may be received by the transceiver (e.g., from the multiplexer 115, etc.) including a plurality of data sets collected from the sensor array 125. Each data set of the plurality of data sets may correspond to a timestamp. In an example, each data set of the plurality of data sets includes data for a first axis, a second axis, and a third axis.

The transceiver 405 may process data for output from the predictive classifier 140. For example, the transceiver 405 may output data to a display (e.g., a display overlay for broadcast television, a webpage, a scoreboard, etc.). The transceiver 405 may forward the incoming data to additional components of the predictive classifier 140 such as the decoder 410.

The decoder 410 may evaluate the incoming data to determine a timestamp corresponding to a start of an action (e.g., the beginning of a trick, etc.). In action sports, jumps, trick, and other action may be a small portion of a run. For example, in slopestyle snowboard competition, a snowboarder may ride down a slope including a variety of terrain elements including jumps, rails, etc. A slopestyle run may last 45 seconds including one or more 5 to 8 second trick segments (e.g., segments that should be analyzed carefully) interspersed with segments between the trick segments that may not be fully analyzed. To address the issue of determining which segments of a run should be carefully analyzed, the decoder 410 may identify the start point of an action in real-time or near real-time without regard to speed or orientation of the participant.

The decoder 410 may calculate the squared-magnitude of accelerometer values included in each data set of the plurality of data sets. For example, the accelerometer data may include magnitude along an x-axis, a y-axis, and a z-axis and the squared magnitude for a given timestamp may be calculated using the function x²+y²+z². Thus, each data set may be compressed into a magnitude value. The decoder 410 may then calculate a first mean and a first standard deviation for a first set of squared magnitude values over a first period of time (e.g., a long range timescale, 1 second worth of data, etc.) and a second mean and a second standard deviation for a second set of squared magnitude values over a second period of time (e.g., a short range timescale, <30 ms worth of data, 3 timestamps, etc.).

During periods of non-action (e.g., ground riding, etc.) a set of corresponding squared magnitude values may show high and changing acceleration. During periods of action (e.g., a trick, etc.) a set of corresponding squared magnitude values may show smooth and slow variation in acceleration. The different characteristics of action and non-action segments of a run may be used to determine a start point of an action. The decoder 410 may calculate a mean ratio for the first mean and the second mean and a standard deviation ratio for the first standard deviation and the second standard deviation. For example, the mean ratio may be calculated using the function Mean_{long}/Meanₛₕₒᵣₜ and the mean standard deviation ratio may be calculated using the function STD_{long}/STDₛₕₒᵣₜ. The mean ration and the standard deviation ratios may indicate when a participant transitions from a non-action segment to an action segment of a run. For example, ratios indicating that the long term data are high while the short term data is low may indicate that the participant has transitioned from a non-action segment to an action segments.

The comparator 415 may compare the mean ratio and the standard deviation to a threshold to generate a starting point for an action based on a determination that the mean ration and the standard deviation are outside the threshold. In an example, the determination that the mean ration and the standard deviation are outside the threshold may include determining that the mean ration and the standard deviation have exceeded a threshold for a consecutive set of time periods. For example, the start of the action may be generated when the mean ration and the standard deviation ratio exceed an empirically derived threshold a three consecutive timestamps in a row. This may limit detection time to five consecutive timestamps after the trick has started which may be an improvement of existing techniques. For example, at 400 Hz, the detection of a start of an event may take place 12.5 ms after the start of the event. Thus, detection may occur in near real-time.

The comparator 415 may detect start events for a variety of action sports such as for example, snowboarding, skiing, skateboarding, wake boarding, etc. by configuring the comparator 415 with one or more thresholds indicating the beginning of an action for the action sport to be analyzed. For example, a threshold for skiing may be three-quarters of a threshold for snowboarding. A threshold may be determined for an action sport by accumulating participant data and fitting two parameters for enhanced accuracy. For example, in snowboarding participant speed and jump duration may be fit to the participant data to eliminate false positives. For example, a participant may come to a sudden stop wherein the accelerometer variance drops to zero quickly as it may in a jump. The comparator 415 may determine that the participant speed has dropped to zero and may discard the generated start point as a false positive.

In some examples, there may be periods of loading time before a participant leaves the ground in which the participant begins to flip, spin, or pop off the ground. These periods of loading time may be useful in classifying or quantifying a trick. To compensate for these portions of data that may be missed during detection, the predictive classifier 140 may retain a portion of data before the start period for the action. For example, one half second of data may be back buffered. The comparator 415 may evaluate the retained portion of the data to determine if a squared magnitude for a timestamps in the retained portion of the data are outside a threshold and, if so, adjusts the generated start point using the evaluation. For example, the retained portion of the data may contain three consecutive timestamps before the generated start point where the squared magnitude exceeds the threshold and the start point may be moved to the first in time of the three timestamps.

After the predictive classifier 140 has determined the start point for an action data may begin to accumulate. The predictive classifier 140 may continue to analyze incoming data using the decoder 410 and the comparator 415 to identify an end point for the action. The action may continue while the accelerometer magnitude remains outside a threshold. The comparator 415 may generate an end point for the action upon detecting that the accelerometer magnitude is outside the threshold.

Upon identification of the start point for the action, the feature extractor 420 may begin to process the data stream subsequent to the start point for the action (e.g., data sets for timestamps occurring after a timestamp corresponding to the start point) to extract action performance features. The feature extractor 420 may analyze the plurality of data sets corresponding to the action included in the data stream to identify a variety of data items (e.g., variables, etc.). For example, values collected from the sensor array 125 about a trick performed by a participant along multiple axes may be analyzed. In an example, the action performance features includes at least one of an incoming speed feature, a rotation feature, a rotational speed feature, and a force feature. The feature extractor 420 may then compress the data items into action performance features. For example, acceleration data from an accelerometer and rotational data from a gyroscope may be compressed to form a rotational speed feature. In some examples, the feature extractor 420 may extract features from a time period before the start point of the action. For example, a second of data prior to the start point may be analyzed to extract features.

The feature extractor 420 may extract action performance features including geo-location features from geo-location data included in the data stream (e.g., global positioning coordinates from a GPS sensor, etc.). The feature extractor 420 may reference stored (e.g., in a database, memory, etc.) course map data to extract the geo-location features. In an example, the feature extractor 420 may select a map from a set of maps using geolocation data included in the data stream. The map may include a plurality of data items corresponding to a location of the action (e.g., a snowboarding course, etc.). In an example, the plurality of data items corresponding to the location may include at least one of a slope of a hill, a height of an obstacle, and a distance to a landing area.

The comparator 415 may compare the action performance features to a set of statistical models. For example, a snowboarder may be attempting a trick and the set of action features may be compared to a set of statistical models representing various snowboarding tricks. The comparator 415 may select a label for the action based on the comparison. For example, the action performance features may be matched with a statistical model having a label of tailgrab and the action may be labeled as a tailgrab. A variety of matching techniques may be used in comparing the action performance features to a statistical model. For example, the comparison may evaluate the action performance features using logistic regression models, multi-variable logistic regression models, and higher order regression models.

The comparator 415 may generate a likelihood of success for the action based on the comparison. For example, the action may be labeled as a tailgrab and the currently evaluated data sets included in the data stream may indicate that that the outcome is likely a failure. In an example, the likelihood of success may be a percentage opportunity for success (or failure). For example, the likelihood of success for the tailgrab performed by the snowboarder may be 85% and the likelihood of failure may be 15%. The comparator may continually evaluate incoming data. Thus, the likelihood of success may vary from the start of the action through performance of the action. For example, at takeoff the likelihood of success may be evaluated as 75% and as the user begins descending the likelihood of success may be evaluated as 25%. In some examples, the comparator 415 may use at least one data item of the plurality of data items corresponding to a location of the trick in generating the likelihood of success. For example, the likelihood of success of a tailgrab on a first jump may be less than the likelihood of success of a tailgrab on a second jump.

The label for the action and the likelihood of success may be output (e.g., using the transceiver 405, etc.) for display on a display device. In some examples, the output of the label for the action and the likelihood of success may include an output of the likelihood of success as a percentage. For example, a label of tailgrab and a likelihood of success of 75% may be output to an electronic overlay used in broadcasting an action sports event, a computing device used by a coach, and a scoreboard placed at the location of the action sports event.

In some examples, a set of historical data may be collected (e.g., using the transceiver, etc.) that corresponds to a set of actions (e.g., multiple tricks, etc.) for an action sport (e.g., snowboarding, etc.). For example, data may be collected from a variety of snowboarders completing a variety of tricks on a snowboarding course with the sensor array affixed to their respective snowboards. The feature extractor 420 may extract past performance features for each action of the set of actions.

The modeler 425 may process the past performance features to generate a model (e.g., a statistical model, a regression model, etc.) for each action of the set of actions. For example, the historical data may include data sets for past performances of a variety of tricks. The data sets may be labeled (e.g., manually, automatically using machine learning techniques, etc.), for example, with a trick name with a success/failure value. Multiple data sets for an action may be combined and evaluated to generate a model including features identified as indicative of success and failure. For example, height from the top of a jump may be indicative of the success of a snowboard trick including a flip. The set of statistical models may be created using the model for each action.

Features may be used for scoring a run of a participant. The run may include one or more actions. For example, a slopestyle snowboarding run may include several tricks performed throughout a course including a number of obstacles. For example, a competitive snowboarding run may include a total number of tricks performed or a total amount of time allowed in which to complete tricks. A set of actions may be identified over the course of the run and may be evaluated to derive scores for each action of the set of actions.

The evaluation may use models generated from past performances for past performances of various actions and past runs including various actions. For example, a regression model may be generated using time and performance features extracted from data sets corresponding with prior actions and runs. The scores for each action of the set of actions may be used to calculate a total score for the run. For example, a run may include a tailgrab and a frontside flip, the tailgrab may be evaluated with a score of 10 points and the frontside flip may be evaluated with a score of 20 points resulting in a total score for the run of 30 points.

In some examples, a plurality of historical data sets may be collected (e.g., using the transceiver 405, etc.) corresponding to the action. For example, data may be collected from several past performances (e.g., by the participant or others, etc.) of a trick during which the sensor array was affixed to the snowboard. Each historical data set of the plurality of historical data sets may include scoring data corresponding to the action. For example, a first performance of the trick may have been issued a score of 85 points and the data set corresponding with the first performance may include the score of 85 points.

The feature extractor 420 may extract a set of score indicator features from the plurality of historical data sets. In an example, the set of score indicator features may include at least one of a difficulty of the action, a success rate of the action, a statistical measure of the action, and a frequency with which the action is performed. The features may include performance of the action for other competitors participating in a current competition in which the action is being performed. For example, if in a given competition many participants appear to fail on the same obstacle, a variable may be computed and used in the evaluation or in generating a regression model.

The modeler 425 may generate a score model for the action using the set of score indicator features. The each historical data set of the plurality of historical data sets corresponding with the action may be labeled (e.g., manually, automatically using machine learning techniques, etc.), for example, with a trick name with a score. The plurality of historical data sets corresponding with the action may be combined and evaluated to generate a model including features identified as indicative of a score.

The comparator 415 may compare the action performance features to the score model. For example, features such as rotational speed, geo-location, and height of a tailgrab performed by a snowboarder may be evaluated to a scoring regression model generated from previous scored performances of a tailgrab. The comparator 415 may determine an action score based on the comparison. For example, the action performance features for the currently performed tailgrab may be matched to a scoring model indicating a score of 25 points and the score for the action may be determined as 25 points. The action score may be output (e.g., using the transceiver 405, etc.) for display on a display device.

In some examples, a set of run scores may be obtained (e.g., using the transceiver 405, etc.) for a run including the action. For example, a snowboarder may have completed three tricks of a five trick run and scores for the first three tricks may be obtained. The calculator 430 may derive a total run score for the run using the set of run scores and the action score. For example, the first three tricks of the run of five tricks may be 15, 20, and 10 points respectively and the score for the current trick (e.g., the action score) may be 25 and the total score may be calculated as 70 points. The total run score may be output (e.g., using the transceiver, etc.) for display on the display device.

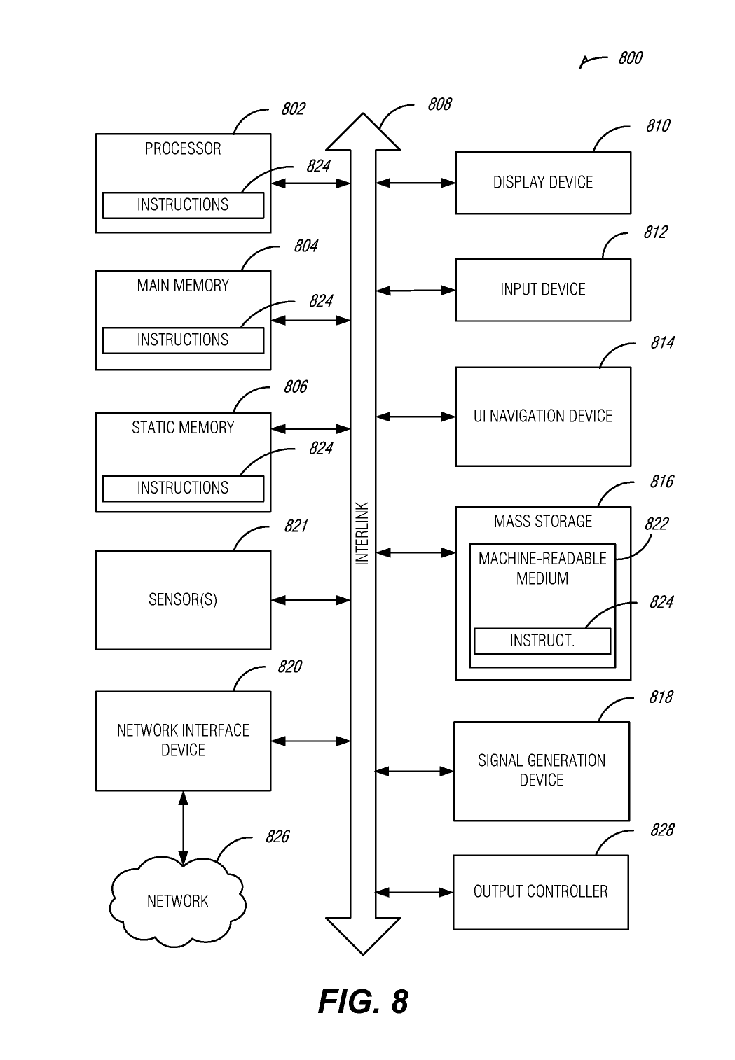

The present subject matter may be implemented in various configurations. For example, the multiplexer 115, the predictive classifier 140, the transceiver 405, the decoder 410, the comparator 415, the feature extractor 420, the modeler 425, and the calculator 430 may be implemented in different (or the same) computing systems (e.g., a single server, a collection of servers, a cloud-based computing platform, etc.). A computing system may comprise one or more processors (e.g., hardware processor 802 described in FIG. 8, etc.) that execute software instructions, such as those used to define a software or computer program, stored in a computer-readable storage medium such as a memory device (e.g., a main memory 804 and a static memory 806 as described in FIG. 8, a Flash memory, random access memory (RAM), or any other type of volatile or non-volatile memory that stores instructions), or a storage device (e.g., a disk drive, or an optical drive). Alternatively, the computing system may comprise dedicated hardware, such as one or more integrated circuits, one or more Application Specific Integrated Circuits (ASICs), one or more Application Specific Special Processors (ASSPs), one or more Field Programmable Gate Arrays (FPGAs), or any combination of the foregoing examples of dedicated hardware, for performing the techniques described in this disclosure.

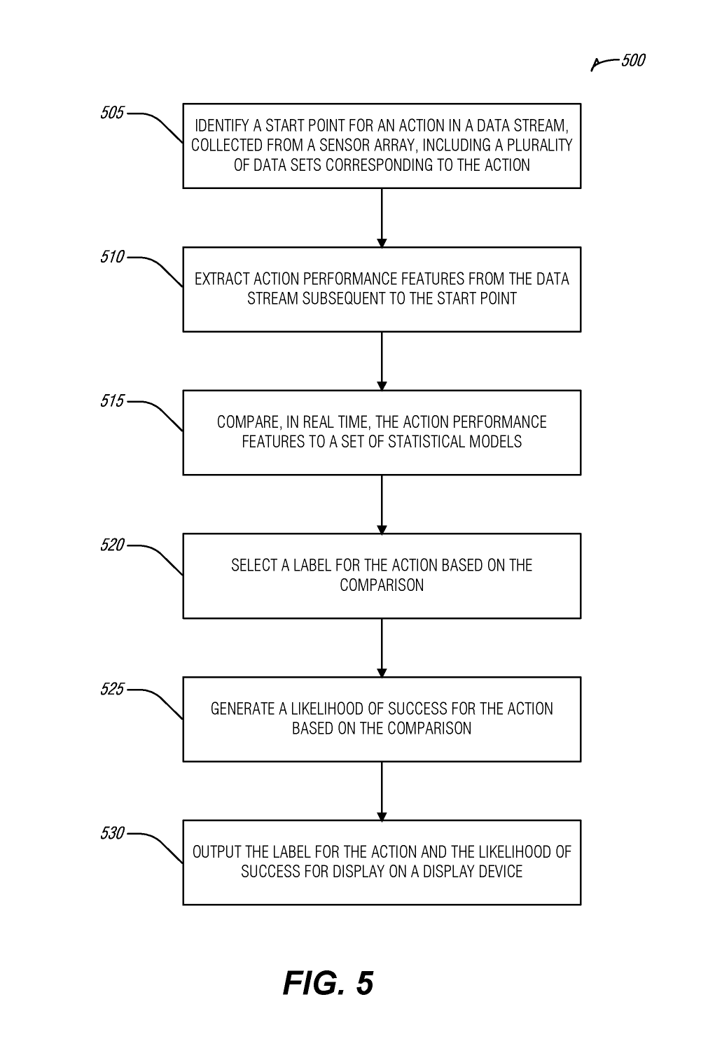

FIG. 5 illustrates a flowchart of an example of a method 500 for predictive classification in action sports, according to various embodiments. The method 500 may provide similar functionality as described in FIG. 4.

At operation 505, a start point for an action may be identified in a data stream including a plurality of data sets corresponding to the action. The data stream may be collected from a sensor array. For example, a snowboarder may have a sensor array (e.g., the sensor array 125 as described in FIG. 1) affixed to a snowboard while traversing a snowboarding course. The sensor array may transmit a data stream (e.g., data from sensors in the sensor array) and it may be identified that the snowboarder has begun ascending a jump to perform a trick. In an example, the sensor array may include an accelerometer, a gyroscope, and a magnetometer. In an example, the sensor array may include a global positioning system (GPS) receiver and a barometer. In an example, each data set of the plurality of data sets may include data for a first axis, a second axis, and a third axis.

At operation 510, action performance features may be extracted from the data stream subsequent to the start point. In some examples, action performance features may be extracted from a time period before the start point of the action. In an example, the action performance features may include at least one of an incoming speed feature, a rotation feature, a rotational speed feature, and a force feature. For example, the snowboarder may be completing a trick including a number of rotations and flips and features may be extracted from the sensor data including the speed at which the snowboard is traveling, rotation angle of the snowboard, rotational speed of the snowboard, etc.

At operation 515, the action performance features may be compared in real time to a set of statistical models. In an example, the set of statistical models may include one or more regression models generated using a set of training data corresponding to past performances of a set of actions for the action sport. In an example, the set of statistical models may be generated using logistical regression modeling. In an example, the set of statistical models may be generated using multi-variable logistical regression modeling. In an example, the set of statistical models may be generated using higher order regression modeling. For example, the features extracted from the data stream from the sensor array affixed to the snowboard may be compared to statistical models generated from past performances of snowboard tricks for which models have been generated.

At operation 520, a label may be selected for the action based on the comparison. In an example, the label may be selected by matching the action performance features to the statistical model and identifying a label corresponding to the statistical model. In an example, the label may be a name of an action corresponding with the model. For example, the snowboarder may be completing a tailgrab and the features extracted from the sensor data may be matched to a model of a tailgrab resulting in a label being assigned to the snowboarder's current action.

At operation 525, a likelihood of success may be generated for the action based on the comparison. In some examples, a map may be selected from a set of maps using geolocation data included in the data stream and the map may include a plurality of data items corresponding to a location of the action. The likelihood of success may be generated using at least one data item of the plurality of data items corresponding to the location. In an example, the plurality of data items corresponding to the location may include at least one of a slope of a hill, a height of an obstacle, and a distance to a landing area. For example, the features of a the snowboarder's tailgrab attempt may be compared to previous tailgrab performances and other information, such as current conditions, performance trends by other competitors, current location details, etc., to determine the likelihood that the snowboarder may successfully complete the tailgrab.

At operation 530, the label for the action and the likelihood of success may be output for display on a display device. In an example, the output for display of the label for the action and the likelihood of success may include output of the likelihood of success as a percentage. For example, a scoreboard place at a snowboarding event may display that the snowboarder is attempting a tailgrab and there is a 75% chance the attempt will be successful.

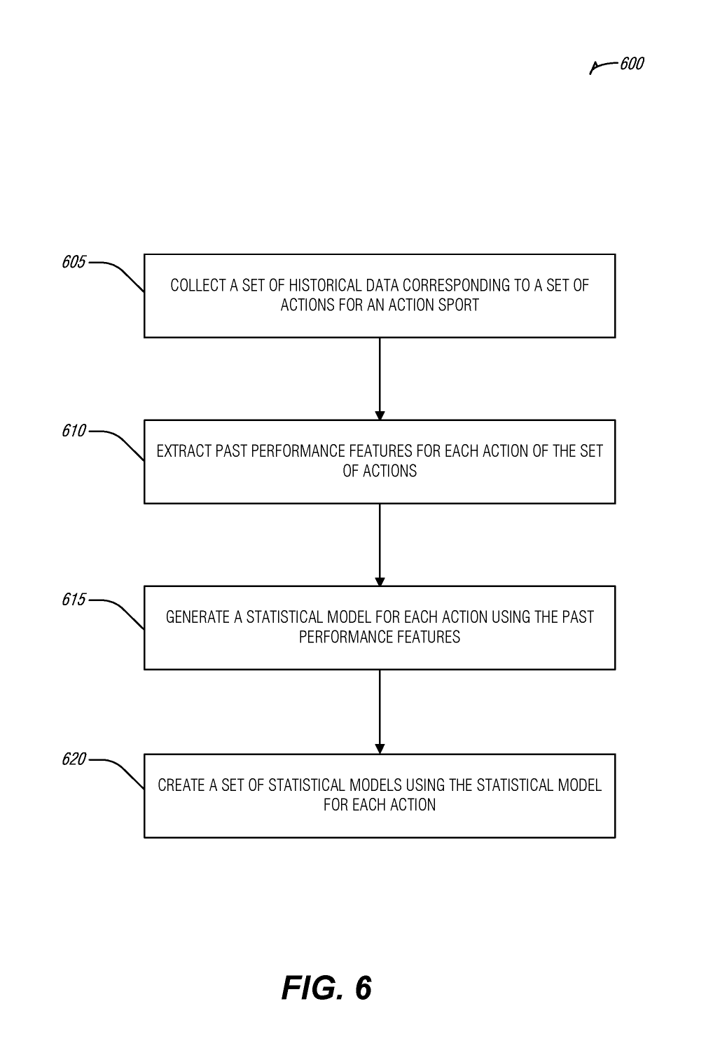

FIG. 6 illustrates a flowchart of an example of a method 600 for predictive classification in action sports, according to various embodiments. The method 600 may provide similar functionality as described in FIG. 4.

At operation 605, a set of historical data corresponding to a set of actions for an action sport may be collected. At operation 610, past performance features may be extracted for each action of the set of actions. At operation 615, a statistical model may be generated for each action using the past performance features. At operation 620, a set of statistical models may be created using the statistical model for each action. For example, several performances of a tailgrab may be performed by a snowboarder with a sensor array affixed to a snowboard and the data collected may be labeled and then analyzed to generate a model for a tailgrab. The model may contain features indicating success and failure of a tailgrab. The model for the tailgrab may then be added to a set of models for snowboard to be used for comparison to identify a trick being performed and the likelihood of success of a performance of the trick.

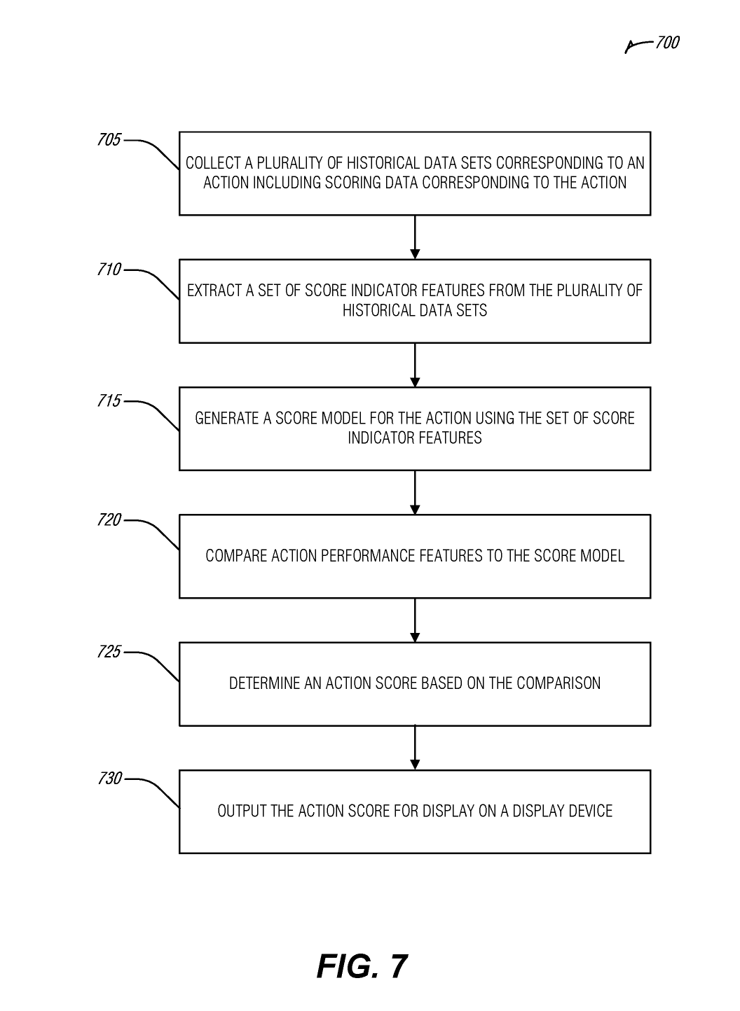

FIG. 7 illustrates a flowchart of an example of a method 700 for predictive classification in action sports, according to various embodiments. The method 700 may provide similar functionality as described in FIG. 4.

At operation 705, a plurality of historical data sets corresponding to the action may be collected. Each historical data set of the plurality of historical data sets may include scoring data corresponding to the action. At operation 710, a set of score indicator features may be extracted from the plurality of historical data sets. In an example, the set of score indicator features may include at least one of a difficulty of the action, a success rate of the action, a statistical measure of the action, and a frequency with which the action is performed. At operation 715, a score model may be generated for the action using the set of score indicator features. At operation 720, action performance features may be compared to the score model. At operation 725, an action score may be determined based on the comparison. At operation 730, the action score may be output for display on a display device.

For example, various snowboarders may complete runs including various tricks with a sensor array affixed to a snowboard. Each performance of a tailgrab may be assigned a score and a scoring model may be created for the tailgrab trick including features indicating higher and lower score values. Data collected from a snowboarder's current tailgrab performance may be compared to the model along with other information, such as current conditions, how often a tailgrab is performed, etc., to determine a score for the tailgrab performance.

In some examples, a set of run scores may be obtained for a run including an action. A total run score may be derived for the run using the set of run scores and the action score. The total run score may be output for display on a display device. For example, the snowboarder may be scored for each trick performed while traversing the snowboarding course and the values of each score may be tallied into a total run score. The total run score for the snowboarder may change as the snowboarder continues to complete tricks on the snowboard course.

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., Universal Serial Bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

### ADDITIONAL NOTES & EXAMPLES

Example 1 is a system for predictive action assessment in action sports, the system comprising: one or more processors; a memory including instructions that, when executed by the one or more processors, cause the one or more processors to perform operations to: identify a start point for an action in a data stream including a plurality of data sets corresponding to the action, the data stream collected from a sensor array; extract action performance features from the data stream subsequent to the start point; compare, in real time, the action performance features to a set of statistical models; select a label for the action based on the comparison; generate a likelihood of success for the action based on the comparison; and output the label for the action and the likelihood of success for display on a display device.

In Example 2, the subject matter of Example 1 optionally includes wherein the instructions to extract the action performance features include instructions to extract features from a time period before the start point of the action.

In Example 3, the subject matter of any one or more of Examples 1-2 optionally include wherein the sensor array includes an accelerometer, a gyroscope, and a magnetometer.

In Example 4, the subject matter of any one or more of Examples 1-3 optionally include wherein the sensor array includes a global positioning system (GPS) receiver and a barometer.

In Example 5, the subject matter of any one or more of Examples 1-4 optionally include instructions that cause the one or more processors to perform operations to: select a map from a set of maps using geolocation data included in the data stream, the map including a plurality of data items corresponding to a location of the action; and wherein the instructions to generate the likelihood of success include instructions to use at least one data item of the plurality of data items corresponding to the location.

In Example 6, the subject matter of Example 5 optionally includes wherein the plurality of data items corresponding to the location includes at least one of a slope of a hill, a height of an obstacle, and a distance to a landing area.

In Example 7, the subject matter of any one or more of Examples 1-6 optionally include wherein the instructions to output the label for the action and the likelihood of success for display include instructions to output the likelihood of success as a percentage.

In Example 8, the subject matter of any one or more of Examples 1-7 optionally include wherein the action performance features includes at least one of an incoming speed feature, a rotation feature, a rotational speed feature, and a force feature.

In Example 9, the subject matter of any one or more of Examples 1-8 optionally include wherein each data set of the plurality of data sets includes data for a first axis, a second axis, and a third axis.

In Example 10, the subject matter of any one or more of Examples 1-9 optionally include instructions that cause the one or more processors to perform operations to: collect a set of historical data corresponding to a set of actions for an action sport; extract past performance features for each action of the set of actions; generate a statistical model for each action using the past performance features; and create the set of statistical models using the statistical model for each action.

In Example 11, the subject matter of any one or more of Examples 1-10 optionally include instructions that cause the one or more processors to perform operations to: collect a plurality of historical data sets corresponding to the action, each historical data set of the plurality of historical data sets including scoring data corresponding to the action; extract a set of score indicator features from the plurality of historical data sets; generate a score model for the action using the set of score indicator features; compare the action performance features to the score model; determine an action score based on the comparison; and output, for display on the display device, the action score.

In Example 12, the subject matter of Example 11 optionally includes instructions that cause the one or more processors to perform operations to: obtain a set of run scores for a run including the action; derive a total run score for the run using the set of run scores and the action score; and output, for display on the display device, the total run score.

In Example 13, the subject matter of any one or more of Examples 11-12 optionally include wherein the set of score indicator features includes at least one of a difficulty of the action, a success rate of the action, a statistical measure of the action, and a frequency with which the action is performed.

Example 14 is at least one computer readable medium including instructions for predictive action assessment in action sports that, when executed by a machine, cause the machine to perform operations to: identify a start point for an action in a data stream including a plurality of data sets corresponding to the action, the data stream collected from a sensor array; extract action performance features from the data stream subsequent to the start point; compare, in real time, the action performance features to a set of statistical models; select a label for the action based on the comparison; generate a likelihood of success for the action based on the comparison; and output the label for the action and the likelihood of success for display on a display device.

In Example 15, the subject matter of Example 14 optionally includes wherein the instructions to extract the action performance features include instructions to extract features from a time period before the start point of the action.

In Example 16, the subject matter of any one or more of Examples 14-15 optionally include wherein the sensor array includes an accelerometer, a gyroscope, and a magnetometer.

In Example 17, the subject matter of any one or more of Examples 14-16 optionally include wherein the sensor array includes a global positioning at least one computer readable medium (GPS) receiver and a barometer.

In Example 18, the subject matter of any one or more of Examples 14-17 optionally include instructions that cause the one or more processors to perform operations to: select a map from a set of maps using geolocation data included in the data stream, the map including a plurality of data items corresponding to a location of the action; and wherein the instructions to generate the likelihood of success include instructions to use at least one data item of the plurality of data items corresponding to the location.

In Example 19, the subject matter of Example 18 optionally includes wherein the plurality of data items corresponding to the location includes at least one of a slope of a hill, a height of an obstacle, and a distance to a landing area.

In Example 20, the subject matter of any one or more of Examples 14-19 optionally include wherein the instructions to output the label for the action and the likelihood of success for display include instructions to output the likelihood of success as a percentage.

In Example 21, the subject matter of any one or more of Examples 14-20 optionally include wherein the action performance features includes at least one of an incoming speed feature, a rotation feature, a rotational speed feature, and a force feature.

In Example 22, the subject matter of any one or more of Examples 14-21 optionally include wherein each data set of the plurality of data sets includes data for a first axis, a second axis, and a third axis.

In Example 23, the subject matter of any one or more of Examples 14-22 optionally include instructions that cause the one or more processors to perform operations to: collect a set of historical data corresponding to a set of actions for an action sport; extract past performance features for each action of the set of actions; generate a statistical model for each action using the past performance features; and create the set of statistical models using the statistical model for each action.

In Example 24, the subject matter of any one or more of Examples 14-23 optionally include instructions that cause the one or more processors to perform operations to: collect a plurality of historical data sets corresponding to the action, each historical data set of the plurality of historical data sets including scoring data corresponding to the action; extract a set of score indicator features from the plurality of historical data sets; generate a score model for the action using the set of score indicator features; compare the action performance features to the score model; determine an action score based on the comparison; and output, for display on the display device, the action score.

In Example 25, the subject matter of Example 24 optionally includes instructions that cause the one or more processors to perform operations to: obtain a set of run scores for a run including the action; derive a total run score for the run using the set of run scores and the action score; and output, for display on the display device, the total run score.

In Example 26, the subject matter of any one or more of Examples 24-25 optionally include wherein the set of score indicator features includes at least one of a difficulty of the action, a success rate of the action, a statistical measure of the action, and a frequency with which the action is performed.

Example 27 is a method for predictive action assessment in action sports, the method comprising: identifying a start point for an action in a data stream including a plurality of data sets corresponding to the action, the data stream collected from a sensor array; extracting action performance features from the data stream subsequent to the start point; comparing, in real time, the action performance features to a set of statistical models; selecting a label for the action based on the comparison; generating a likelihood of success for the action based on the comparison; and outputting the label for the action and the likelihood of success for display on a display device.

In Example 28, the subject matter of Example 27 optionally includes wherein extracting the action performance features includes extracting features from a time period before the start point of the action.

In Example 29, the subject matter of any one or more of Examples 27-28 optionally include wherein the sensor array includes an accelerometer, a gyroscope, and a magnetometer.

In Example 30, the subject matter of any one or more of Examples 27-29 optionally include wherein the sensor array includes a global positioning system (GPS) receiver and a barometer.

In Example 31, the subject matter of any one or more of Examples 27-30 optionally include selecting a map from a set of maps using geolocation data included in the data stream, the map including a plurality of data items corresponding to a location of the action; and wherein generating the likelihood of success includes using at least one data item of the plurality of data items corresponding to the location.

In Example 32, the subject matter of Example 31 optionally includes wherein the plurality of data items corresponding to the location includes at least one of a slope of a hill, a height of an obstacle, and a distance to a landing area.

In Example 33, the subject matter of any one or more of Examples 27-32 optionally include wherein outputting the label for the action and the likelihood of success for display includes outputting the likelihood of success as a percentage.

In Example 34, the subject matter of any one or more of Examples 27-33 optionally include wherein the action performance features includes at least one of an incoming speed feature, a rotation feature, a rotational speed feature, and a force feature.

In Example 35, the subject matter of any one or more of Examples 27-34 optionally include wherein each data set of the plurality of data sets includes data for a first axis, a second axis, and a third axis.

In Example 36, the subject matter of any one or more of Examples 27-35 optionally include collecting a set of historical data corresponding to a set of actions for an action sport; extracting past performance features for each action of the set of actions; generating a statistical model for each action using the past performance features; and creating the set of statistical models using the statistical model for each action.

In Example 37, the subject matter of any one or more of Examples 27-36 optionally include collecting a plurality of historical data sets corresponding to the action, each historical data set of the plurality of historical data sets including scoring data corresponding to the action; extracting a set of score indicator features from the plurality of historical data sets; generating a score model for the action using the set of score indicator features; comparing the action performance features to the score model; determining an action score based on the comparison; and outputting, for display on the display device, the action score.

In Example 38, the subject matter of Example 37 optionally includes obtaining a set of run scores for a run including the action; deriving a total run score for the run using the set of run scores and the action score; and outputting, for display on the display device, the total run score.

In Example 39, the subject matter of any one or more of Examples 37-38 optionally include wherein the set of score indicator features includes at least one of a difficulty of the action, a success rate of the action, a statistical measure of the action, and a frequency with which the action is performed.

Example 40 is a system to implement predictive action assessment in action sports, the system comprising means to perform any method of Examples 27-39.

Example 41 is at least one machine readable medium to implement predictive action assessment in action sports, the machine readable medium including instructions that, when executed by a machine, cause the machine to perform any method of Examples 27-39.

Example 42 is a system for predictive action assessment in action sports, the system comprising: means for identifying a start point for an action in a data stream including a plurality of data sets corresponding to the action, the data stream collected from a sensor array; means for extracting action performance features from the data stream subsequent to the start point; means for comparing, in real time, the action performance features to a set of statistical models; means for selecting a label for the action based on the comparison; means for generating a likelihood of success for the action based on the comparison; and means for outputting the label for the action and the likelihood of success for display on a display device.

In Example 43, the subject matter of Example 42 optionally includes wherein the means for extracting the action performance features includes means for extracting features from a time period before the start point of the action.

In Example 44, the subject matter of any one or more of Examples 42-43 optionally include wherein the sensor array includes an accelerometer, a gyroscope, and a magnetometer.

In Example 45, the subject matter of any one or more of Examples 42-44 optionally include wherein the sensor array includes a global positioning system (GPS) receiver and a barometer.

In Example 46, the subject matter of any one or more of Examples 42-45 optionally include means for selecting a map from a set of maps using geolocation data included in the data stream, the map including a plurality of data items corresponding to a location of the action; and wherein the means for generating the likelihood of success includes means for using at least one data item of the plurality of data items corresponding to the location.

In Example 47, the subject matter of Example 46 optionally includes wherein the plurality of data items corresponding to the location includes at least one of a slope of a hill, a height of an obstacle, and a distance to a landing area.

In Example 48, the subject matter of any one or more of Examples 42-47 optionally include wherein the means for outputting the label for the action and the likelihood of success for display includes means for outputting the likelihood of success as a percentage.

In Example 49, the subject matter of any one or more of Examples 42-48 optionally include wherein the action performance features includes at least one of an incoming speed feature, a rotation feature, a rotational speed feature, and a force feature.

In Example 50, the subject matter of any one or more of Examples 42-49 optionally include wherein each data set of the plurality of data sets includes data for a first axis, a second axis, and a third axis.

In Example 51, the subject matter of any one or more of Examples 42-50 optionally include means for collecting a set of historical data corresponding to a set of actions for an action sport; means for extracting past performance features for each action of the set of actions; means for generating a statistical model for each action using the past performance features; and means for creating the set of statistical models using the statistical model for each action.

In Example 52, the subject matter of any one or more of Examples 42-51 optionally include means for collecting a plurality of historical data sets corresponding to the action, each historical data set of the plurality of historical data sets including scoring data corresponding to the action; means for extracting a set of score indicator features from the plurality of historical data sets; means for generating a score model for the action using the set of score indicator features; means for comparing the action performance features to the score model; means for determining an action score based on the comparison; and means for outputting, for display on the display device, the action score.

In Example 53, the subject matter of Example 52 optionally includes means for obtaining a set of run scores for a run including the action; means for deriving a total run score for the run using the set of run scores and the action score; and means for outputting, for display on the display device, the total run score.

In Example 54, the subject matter of any one or more of Examples 52-53 optionally include wherein the set of score indicator features includes at least one of a difficulty of the action, a success rate of the action, a statistical measure of the action, and a frequency with which the action is performed.

What is claimed is:

1. A system for predictive action assessment in action sports, the system comprising:
one or more processors;
a memory including instructions that, when executed by the one or more processors, cause the one or more processors to perform operations to:
identify a start point for an action in a data stream including a plurality of data sets corresponding to the action, the data stream collected from a sensor array;
extract action performance features from the data stream subsequent to the start point;
compare, in real time, the action performance features to a set of statistical models;
select a label for the action based on the comparison;
generate a likelihood of success for the action based on the comparison; and
output the label for the action and the likelihood of success for display on a display device.

2. The system of claim 1, wherein the instructions to extract the action performance features include instructions to extract features from a time period before the start point of the action.

3. The system of claim 1, further comprising instructions that cause the one or more processors to perform operations to:
select a map from a set of maps using geolocation data included in the data stream, the map including a plurality of data items corresponding to a location of the action; and
wherein the instructions to generate the likelihood of success include instructions to use at least one data item of the plurality of data items corresponding to the location.

4. The system of claim 1, further comprising instructions that cause the one or more processors to perform operations to:
collect a set of historical data corresponding to a set of actions for an action sport;
extract past performance features for each action of the set of actions;
generate a statistical model for each action using the past performance features; and
create the set of statistical models using the statistical model for each action.

5. The system of claim 1, further comprising instructions that cause the one or more processors to perform operations to:
collect a plurality of historical data sets corresponding to the action, each historical data set of the plurality of historical data sets including scoring data corresponding to the action;
extract a set of score indicator features from the plurality of historical data sets;
generate a score model for the action using the set of score indicator features;
compare the action performance features to the score model;
determine an action score based on the comparison; and
output, for display on the display device, the action score.

6. The system of claim 5, further comprising instructions that cause the one or more processors to perform operations to:
obtain a set of run scores for a run including the action;
derive a total run score for the run using the set of run scores and the action score; and
output, for display on the display device, the total run score.

7. The system of claim 5, wherein the set of score indicator features includes at least one of a difficulty of the action, a success rate of the action, a statistical measure of the action, and a frequency with which the action is performed.

8. At least one computer readable medium including instructions for predictive action assessment in action sports that, when executed by a machine, cause the machine to perform operations to:
identify a start point for an action in a data stream including a plurality of data sets corresponding to the action, the data stream collected from a sensor array;
extract action performance features from the data stream subsequent to the start point;
compare, in real time, the action performance features to a set of statistical models;
select a label for the action based on the comparison;
generate a likelihood of success for the action based on the comparison; and
output the label for the action and the likelihood of success for display on a display device.

9. The at least one computer readable medium of claim 8, wherein the instructions to extract the action performance features include instructions to extract features from a time period before the start point of the action.

10. The at least one computer readable medium of claim 8, further comprising instructions that cause the one or more processors to perform operations to:
select a map from a set of maps using geolocation data included in the data stream, the map including a plurality of data items corresponding to a location of the action; and
wherein the instructions to generate the likelihood of success include instructions to use at least one data item of the plurality of data items corresponding to the location.

11. The at least one computer readable medium of claim 8, further comprising instructions that cause the one or more processors to perform operations to:
collect a set of historical data corresponding to a set of actions for an action sport;
extract past performance features for each action of the set of actions;
generate a statistical model for each action using the past performance features; and
create the set of statistical models using the statistical model for each action.

12. The at least one computer readable medium of claim 8, further comprising instructions that cause the one or more processors to perform operations to:
collect a plurality of historical data sets corresponding to the action, each historical data set of the plurality of historical data sets including scoring data corresponding to the action;
extract a set of score indicator features from the plurality of historical data sets;
generate a score model for the action using the set of score indicator features;
compare the action performance features to the score model;
determine an action score based on the comparison; and
output, for display on the display device, the action score.

13. The at least one computer readable medium of claim 12, further comprising instructions that cause the one or more processors to perform operations to:
obtain a set of run scores for a run including the action;
derive a total run score for the run using the set of run scores and the action score; and
output, for display on the display device, the total run score.

14. The at least one computer readable medium of claim 12, wherein the set of score indicator features includes at least one of a difficulty of the action, a success rate of the action, a statistical measure of the action, and a frequency with which the action is performed.

15. A method for predictive action assessment in action sports, the method comprising:
identifying a start point for an action in a data stream including a plurality of data sets corresponding to the action, the data stream collected from a sensor array;
extracting action performance features from the data stream subsequent to the start point;
comparing, in real time, the action performance features to a set of statistical models;
selecting a label for the action based on the comparison;
generating a likelihood of success for the action based on the comparison; and
outputting the label for the action and the likelihood of success for display on a display device.

16. The method of claim 15, wherein extracting the action performance features includes extracting features from a time period before the start point of the action.

17. The method of claim 15, further comprising:
selecting a map from a set of maps using geolocation data included in the data stream, the map including a plurality of data items corresponding to a location of the action; and
wherein generating the likelihood of success includes using at least one data item of the plurality of data items corresponding to the location.

18. The method of claim 15, further comprising:
collecting a set of historical data corresponding to a set of actions for an action sport;
extracting past performance features for each action of the set of actions;
generating a statistical model for each action using the past performance features; and
creating the set of statistical models using the statistical model for each action.

19. The method of claim 15, further comprising:
collecting a plurality of historical data sets corresponding to the action, each historical data set of the plurality of historical data sets including scoring data corresponding to the action;
extracting a set of score indicator features from the plurality of historical data sets;
generating a score model for the action using the set of score indicator features;
comparing the action performance features to the score model;
determining an action score based on the comparison; and
outputting, for display on the display device, the action score.

20. The method of claim 19, further comprising:
obtaining a set of run scores for a run including the action;
deriving a total run score for the run using the set of run scores and the action score; and
outputting, for display on the display device, the total run score.

21. The method of claim 19, wherein the set of score indicator features includes at least one of a difficulty of the action, a success rate of the action, a statistical measure of the action, and a frequency with which the action is performed.
